(19) United States
(12) Patent Application Publication
(10) Pub. No.: US 2010/0220300 A1
(43) Pub. Date: Sep. 2, 2010

(54) PROJECTION DISPLAY APPARATUS

(76) Inventors: Jun KONDO, Tokyo (JP); Kuniko Kojima, Tokyo (JP); Tomohiro Sasagawa, Tokyo (JP)

Correspondence Address: BIRCH STEWART KOLASCH & BIRCH, PO BOX 747, FALLS CHURCH, VA, 22040-0747, US

(21) Appl. No.: 12/710,976

(22) Filed: Feb. 23, 2010

(30) Foreign Application Priority Data
Mar. 2, 2009 (JP) 2009-047761
Nov. 17, 2009 (JP) 2009-262087

(51) Int. Cl. G03B 21/14; G03B 21/28

(52) U.S. Cl. 353/81; 353/88

(57) ABSTRACT

Provided is a projection display apparatus capable of avoiding decreasing efficiency in the use of a light beam propagating from a light source, thereby to display a high-quality image. The projection display apparatus includes: a light source for emitting a coherent light beam; a light valve having an image-forming region for modulating a light beam propagating from the light source, thereby to generate and emit an image light beam; a lighting-optical system for guiding to the image-forming region the light beam propagating from the light source; a projection-optical system for enlarging and projecting the image light beam emitted by the image-forming region; and a diffusion device located in the lighting-optical system and in the vicinity of a position optically conjugated with the image-forming region. The diffusion device has a structure in which a plurality of microscopic optical elements is regularly arranged on a base plane perpendicular to a propagation direction of a light beam propagating from the light source.

### BACKGROUND OF THE INVENTION

1. Field of the Invention

The present invention relates to a projection display apparatus for projecting an image onto a screen, and more particularly, to a projection display apparatus for projecting an image onto a screen using a light valve such as a digital micromirror device (hereinafter referred to as “DMD”) or a reflective liquid crystal display.

2. Description of the Related Art

Lamps such as extra-high pressure mercury discharge lamps and metal halide lamps have been conventionally used as light sources of projection displays. These lamps however have a problem of a short operating life, and require maintenance such as lamp replacement. There is a further problem with these lamps in that a specific optical system is required for generating light of red, green, and blue from white light emitted by the lamps, thus causing complex structures of the projection displays and low efficiency in the use of the white light.

To solve the above-described problems, various attempts have been made by using laser sources such as semiconductor laser diodes. The laser sources have a long operating life compared with the lamps, and there is little need for maintenance. The laser sources can be directly modulated for displaying an image so that projection displays can have a simple structure and enable improvement of efficiency in the use of light emitted by the laser sources. The laser sources can further reproduce a wide range of colors.

Nonetheless, since the laser sources have relatively high coherence, when the laser sources are used as light sources of the projection displays, scintillation or speckle noises (also referred to as “speckle”) can be observed undesirably in an image displayed on a projection screen. The scintillation is a problematic phenomenon in which incident light beams on the projection screen interfere with each other in irregular phase relationship. The resulting interference pattern can be seen as scintillation of the displayed image by a viewer. Suppression of the scintillation or speckle noises is important when the laser sources are used. A method for suppressing the scintillation or speckle noises is proposed in, for example, U.S. Pat. No. 5,313,479 and its counterpart Japanese Patent Application Publication No. H06-208089 which disclose that a diffusing element made of a diffusing material such as ground glass is rotated or vibrated in an optical system to suppress the speckle.

However, it is difficult with the diffusing element made of the ground glass described above to obtain scattering characteristics suitable for the optical system, since the ground glass has a structure in which microparticles as scattering materials are randomly dispersed in a glass block. There is a possibility that the use of the diffusing element may decrease efficiency in the use of light, since the U.S. Pat. No. 5,313,479 and its counterpart do not propose any concrete information about optimal scattering characteristics of the diffusing element for suppressing the scintillation or the speckle.

### SUMMARY OF THE INVENTION

In view of the foregoing, it is an object of the present invention to provide a projection display apparatus capable of avoiding decrease in efficiency in the use of a light beam propagating from a light source and of effectively suppressing scintillation, thereby to display a high-quality image.

According to one aspect of the present invention, there is provided a projection display apparatus which includes: at least one light source for emitting a coherent light beam; a light valve having an image-forming region for modulating a light beam propagating from the at least one light source, thereby to generate and emit an image light beam; a lighting-optical system for guiding to the image-forming region the light beam propagating from the at least one light source; a projection-optical system for enlarging and projecting the image light beam emitted by the image-forming region; and a diffusion device located in the lighting-optical system, the diffusion device being located at or in a vicinity of a position optically conjugated with the image-forming region, and having a structure in which a plurality of microscopic optical elements is regularly arranged on a base plane perpendicular to a propagation direction of a light beam propagating from the at least one light source.

### BRIEF DESCRIPTION OF THE DRAWINGS

Other aspects and advantages of the invention will become more apparent from the following detailed description, taken in conjunction with the attached drawings.

In the attached drawings:

FIG. 1 schematically illustrates optical systems of a projection display apparatus of a first embodiment according to the present invention;

FIG. 2 schematically illustrates a concept of function of a lighting-optical system in the projection display apparatus of the first embodiment;

FIG. 3 illustrates an ideal angular distribution of light reflected and emitted by a light-receiving surface of a DMD of the first embodiment;

FIGS. 4A to 4C schematically illustrate the shape of a diffusion device used in the projection display apparatus of the first embodiment;

FIG. 5A graphically illustrates an effect produced by a projection display apparatus with no diffusion device;

FIG. 5B graphically illustrates an effect produced by the diffusion device of the projection display apparatus of the first embodiment;

FIG. 6 illustrates refraction of light;

FIG. 7 schematically illustrates the refraction of light passing through the diffusion device of the first embodiment;

FIG. 8 schematically illustrates an optical function of the diffusion device used in the projection display apparatus of the first embodiment;

FIG. 9 schematically illustrates another optical function of the diffusion device used in the projection display apparatus of the first embodiment;

FIG. 10 graphically illustrates an effect produced by the diffusion device used in the projection display apparatus of the first embodiment;

FIGS. 11A and 11B schematically illustrate the shape of a diffusion device used in a projection display apparatus of a second embodiment;

FIG. 12A graphically illustrates an effect produced by a projection display apparatus with no diffusion device;

FIG. 12B graphically illustrates an effect produced by the diffusion device used in the projection display apparatus of the second embodiment;

FIG. 13 schematically illustrates the shape of a diffusion device used in a projection display apparatus of a third embodiment;

FIGS. 14A to 14C schematically illustrate the shape of a diffusion device used in a projection display apparatus of a fourth embodiment;

FIG. 15 schematically illustrates the shape of a diffusion device used in a projection display apparatus of a fifth embodiment; and

FIGS. 16A to 16C schematically illustrate the shape of a diffusion device used in a projection display apparatus of a sixth embodiment.

### DETAILED DESCRIPTION OF THE INVENTION

In the following description, numerous specific details are set forth in order to provide a thorough understanding of the present invention. It will be apparent, however, to one skilled in the art that the present invention may be practiced without some or all of these specific details.

### First Embodiment

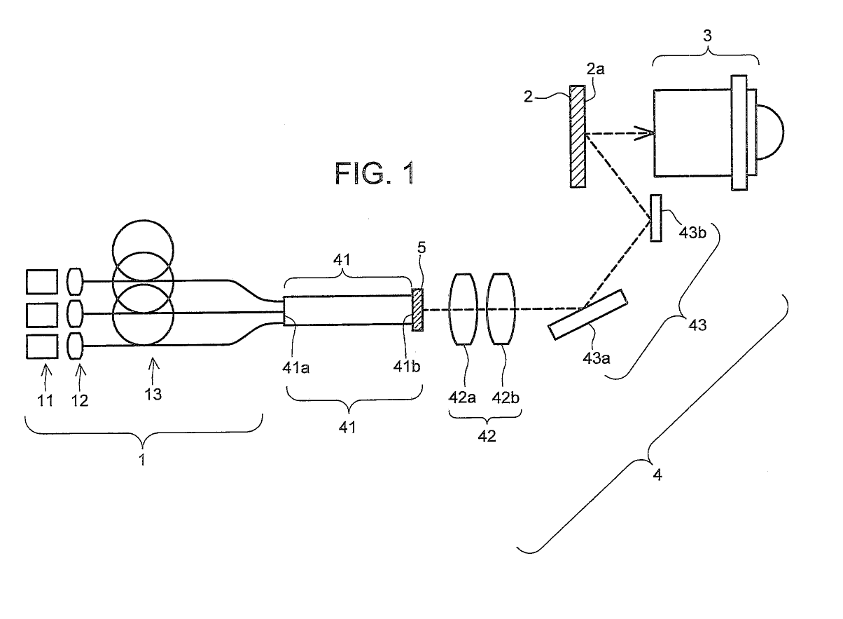

FIG. 1 schematically illustrates optical systems of a projection display apparatus of a first embodiment according to the present invention. As illustrated in FIG. 1, the projection display apparatus of the first embodiment includes: a condensing-optical system 1; a lighting-optical system 4; a DMD 2 that is a reflective light valve and has a light-receiving surface (or an image-forming region) 2a which modulates a light beam collected by the lighting-optical system 4; and a projection-optical system 3 that enlarges and projects, to a screen (not illustrated), an image light beam generated by the light-receiving surface 2a. The condensing-optical system 1 includes: laser sources 11 that emit light of their respective specific colors (e.g., red, green, and blue); condensing-optical devices 12 with each device comprised of one or more lenses and/or mirrors (three lenses in FIG. 1 as an example) for condensing one or more light beams emitted by the laser sources 11; and optical fibers 13 (three optical fibers in FIG. 1 as an example) that guide to the lighting-optical system 4 one or more light beams emitted by the condensing-optical devices 12. A light valve (e.g., a liquid crystal device) other than the DMD can be used for modulating light beam incident from the lighting-optical system 4 based on an input image signal and for emitting the modulated light beam (i.e., an image light beam).

The lighting-optical system 4 includes: a light-intensity uniform device 41 that makes the intensity distribution of a light beam emitted by the condensing-optical system 1 uniform; a relay lens group 42 comprised of optical lenses 42a and 42b; a mirror group 43 comprised of a first mirror 43a and a second mirror 43b. The relay lens group 42 is illustrated in FIG. 1 as being comprised of two optical lenses 42a and 42b, no limitation thereto intended. The relay lens group 42 can be comprised of three or more optical lenses. Similarly, the mirror group 43 is illustrated as being comprised of two mirrors, no limitation thereto intended. The mirror group 43 can be comprised of three or more mirrors. These relay lens group 42 and mirror group 43 guide to the DMD 2 a light beam emitted by the light-intensity uniform device 41.

The light-intensity uniform device 41 has an optical function of making the intensity of the light beam emitted by the condensing-optical system 1 uniform, thereby to reduce spatial nonuniformity of illumination intensity. As the light-intensity uniform device 41, a rod-shaped member typically can be used. The rod-shaped member (e.g., a columnar member) can have a polygon shape (i.e., a polygon shape in cross-section) and inside surfaces at which total internal reflection occurs, and can be made of optically transparent material such as glass or resin. Alternatively, a pipe-shaped member typically can be used as the light-intensity uniform device 41. The pipe-shaped member (e.g., a tubular member) can have a polygon shape in cross-section, and can be tubular in outer shape by binding several members together so as to have their respective inner surfaces with light reflection characteristics. The rod-shaped member as the light-intensity uniform device 41 causes light to be reflected a number of times by using the total internal reflection occurring on a boundary face between the optically transparent material and air medium, and a light-emitting section (a light-emitting end) of the rod-shaped member emits the resulting light beam. The pipe-shaped member as the light-intensity uniform device 41 causes light to be reflected a number of times by using light reflection occurring on plane mirrors facing to its inner side, and the resulting light beam is emitted by a light-emitting section of the pipe-shaped member. With an appropriate length in the direction of light beam propagation, the light-intensity uniform device 41 causes light beams to be internally reflected a number of times, and the resulting light beams are superposed at or in the vicinity of a light-emitting section 41b of the light-intensity uniform device 41, thereby generating the substantial uniformity of the spatial distribution of light intensity at or in the vicinity of the light-emitting section 41b. The emitted light beam having the substantial uniformity of the spatial distribution is guided to the DMD 2, and collected on the light-receiving surface 2a of the DMD 2 by the relay lens group 42 and the mirror group 43.

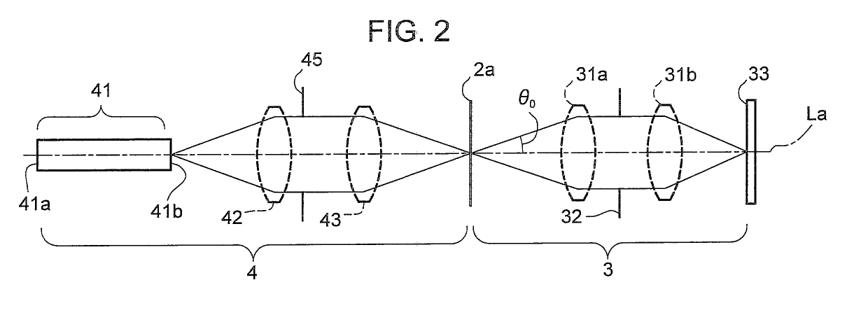

FIG. 2 schematically illustrates a concept of function of the lighting-optical system 4. In FIG. 2, for schematic drawing, the relay lens group 42 is illustrated by the broken line representing a single lens, and the mirror group 43 is illustrated by the broken line representing a single lens. In the lighting-optical system 4 of the first embodiment, the light-receiving surface 2a of the DMD 2 and the light-emitting section 41b of the light-intensity uniform device 41 are positioned so as to be optically conjugated with each other. As illustrated in FIG. 2, the light beam emitted by the light-emitting section 41b propagates along the optical axis La, and is collected on the light-receiving surface 2a by the relay lens group 42 and the mirror group 43. The light-receiving surface 2a of the DMD 2 modulates a light beam incident from the mirror group 43. In the projection-optical system 3, projection lenses 31a, a pupil or aperture 32, and projection lenses 31b collect the modulated light beam to provide an image.

The DMD 2 has a structure in which micromirrors (e.g., hundreds of thousands of micromirrors) are movable and arranged in a two-dimensional array, and the micromirrors correspond to their respective pixels. The tilt angle of each micromirror is controlled to be changed in response to pixel information. We assume that the plane on which the micromirrors are arranged (e.g., a top surface of a substrate on which the micromirrors are formed) is a base plane. When, in response to image information, the DMD 2 causes the micromirrors to be individually tilted at a predetermined angle α (e.g., plus 12 degrees) toward a predetermined direction relative to the base plane, the tilted micromirrors cause an incident light beam to be reflected in the direction of the projection-optical system 3, and the light beam reflecting off the tilted micromirrors enters into the projection-optical system 3 for the use of image projection to a screen (not illustrated). When, in response to image information, the DMD 2 causes the micromirrors to be individually tilted at a predetermined angle β (e.g., minus 12 degrees) different from the predetermined angle α relative to the base plane, the tilted micromirrors cause an incident light beam to be reflected in the direction of a light absorption plate (not illustrated), and the light beam reflecting off the tilted micromirrors enters into the light absorption plate so as not to be used for image projection to the screen. In this manner, the DMD 2 is capable of controlling the reflection of the incident light beam toward the projection-optical system 3 on a pixel-by-pixel basis.

A method using a diffusion effect provided by the diffusion device 5 for suppressing the scintillation caused by the use of a light source such as a laser source that emits a coherent light beam will now be described.

When various wave fronts enter into a screen 33 (illustrated in FIG. 2), these wave fronts form interference patterns at the screen 33. The interference patterns are superposed to form an averaged pattern which can be seen by a viewer. This is the reason that the scintillation is suppressed. An effective method for causing the various wave fronts to enter into the screen 33 is to spread the angular distribution of light entering into the screen 33 and to improve the uniformity of the angular distribution. With the diffusion effect, the diffusion device 5 is capable of controlling the angle of incidence of light entering into the screen 33, thereby spreading and making the angular distribution uniform.

In the light of the above, the position of the diffusion device 5 for suppressing the scintillation will be described. Referring to FIG. 2, the following two candidate positions of the diffusion device 5 for controlling the angle of incidence of the light entering into the screen 33 can be considered. One is a position at or in the vicinity of the light-receiving surface 2a of the DMD 2, which is optically conjugated with the screen 33. The other is a position at or in the vicinity of the light-emitting section 41b of the light-intensity uniform device 41. If the diffusion device 5 is positioned in the space between the light-receiving surface 2a and the screen 33 (i.e., in the projection-optical system 3), a considerable image blurring occurs. In consideration of this, the diffusion device 5 of the first embodiment is positioned at or in the vicinity of the light-emitting section 41b of the light-intensity uniform device 41.

In order to validate the position of the diffusion device 5, the experiment was performed for studying occurrences of scintillation when the diffusion device 5 is placed at each of the following three positions in the lighting-optical system 4: a position of a light-receiving section 41a of the light-intensity uniform device 41 where the light-receiving section 41a is optically conjugated with the entrance pupil of the projection-optical system 3; a position 45 of the aperture stop of the lighting-optical system 4; and a position of the light-emitting section 41b (a conjugate position) of the light-intensity uniform device 41 where the light-emitting section 41b is optically conjugated with the light-receiving surface 2a of the DMD 2. The result of the experiment is summarized in TABLE 1. It is noted that the position of the light-receiving section 41a (a conjugate position) should be a position that is substantially considered as being a conjugate position by one skilled in the art. Namely, the position of the light-receiving section 41a can be a position in the neighbourhood or vicinity of the light-emitting section 41b. Similarly, the position of the light-receiving section 41a can be a position in the neighbourhood or vicinity of the light-receiving section 41a. The diffusion device 5 used in this experiment is commonly called the holographic diffusion grating. The diffusion device 5 has a holographic pattern that is formed on a substrate and is configured to specify one or more diffusion angles of light.

TABLE 1

| POSITION OF DIFFUSION DEVICE | DEGREE OF SCINTILLATION |
|---|---|
| NO DIFFUSION DEVICE | “+” (HIGH) |
| IN THE NEIGHBOURHOOD OF | “Δ” |
| LIGHT-RECEIVING SECTION 41a | |
| OF LIGHT-INTENSITY UNIFORM | |
| DEVICE 41 | |
| IN THE NEIGHBOURHOOD OF | “−” (LOW) |
| LIGHT-EMITTING SECTION 41b | |
| OF LIGHT-INTENSITY UNIFORM | |
| DEVICE 41 | |
| IN THE NEIGHBOURHOOD OF THE | “Δ” |
| POSITION 45 OF APERTURE STOP | |
| OF LIGHTING-OPTICAL SYSTEM 4 | |

As summarized in TABLE 1, in the case when the diffusion device 5 was not placed in the lighting-optical system 4, strong scintillation occurred (as indicated by the plus mark “+” in TABLE 1) during this experiment. In the case when the diffusion device 5 was placed in the neighbourhood or vicinity of the light-receiving section 41a of the light-intensity uniform device 41, scintillation was suppressed to some extent (as indicated by the triangle mark “Δ” in TABLE 1) during this experiment. In the case when the diffusion device 5 was placed in the neighbourhood or vicinity of the position 45 of the aperture stop of the lighting-optical system 4, scintillation was suppressed to some extent (as indicated by the triangle mark “A” in TABLE 1) during this experiment. In the case when the diffusion device 5 was placed in the neighbourhood or vicinity of the light-emitting section 41b of the light-intensity uniform device 41, scintillation was mostly suppressed (as indicated by the minus mark “−” in TABLE 1) during this experiment.

As is understood from TABLE 1, when the same diffusion device 5 was placed at the above-described positions, the most noticeable effect for suppressing scintillation is achieved in the case when the diffusion device 5 was placed in the neighbourhood or vicinity of the light-emitting section 41b that is positioned in the light-intensity uniform device 41 and optically conjugated with the light-receiving surface 2a of the DMD 2. Based on this experimental result, the diffusion device 5 of the first embodiment is placed at or in the neighbourhood of the light-emitting section 41b of the light-intensity uniform device 41.

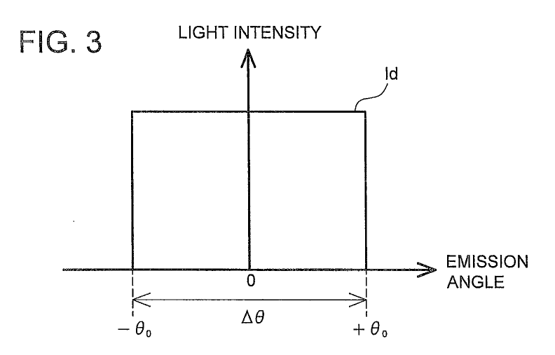

FIG. 3 illustrates an ideal angular distribution Id of light reflected and emitted by the light-receiving surface 2a of the DMD 2. In FIG. 3, the horizontal axis represents emission angle in degrees and the vertical axis represents light intensity. The light intensity for an emission angle of zero degrees is the intensity of a light beam emitted in the direction parallel to a central axis (i.e., an optical axis) of the projection-optical system 3. The emission angle of light exhibits its maximum value when the light emitted by the center of the light-receiving surface 2a passes through the edge of the pupil or aperture 32 of the projection-optical system 3 as illustrated in FIG. 2. θ₀ of FIG. 3 denotes the maximum value (a maximum angle). Light entering into the pupil or aperture 32 at an angle larger than the maximum angle θ₀ dissipates in the projection-optical system 3. Therefore, an effective method for suppressing scintillation and for avoiding decreasing efficiency in the use of light is to improve, in the angle range Δθ from +θ₀ to −θ₀, the uniformity of the angular distribution of light emitted by the light-receiving surface 2a of the DMD 2.

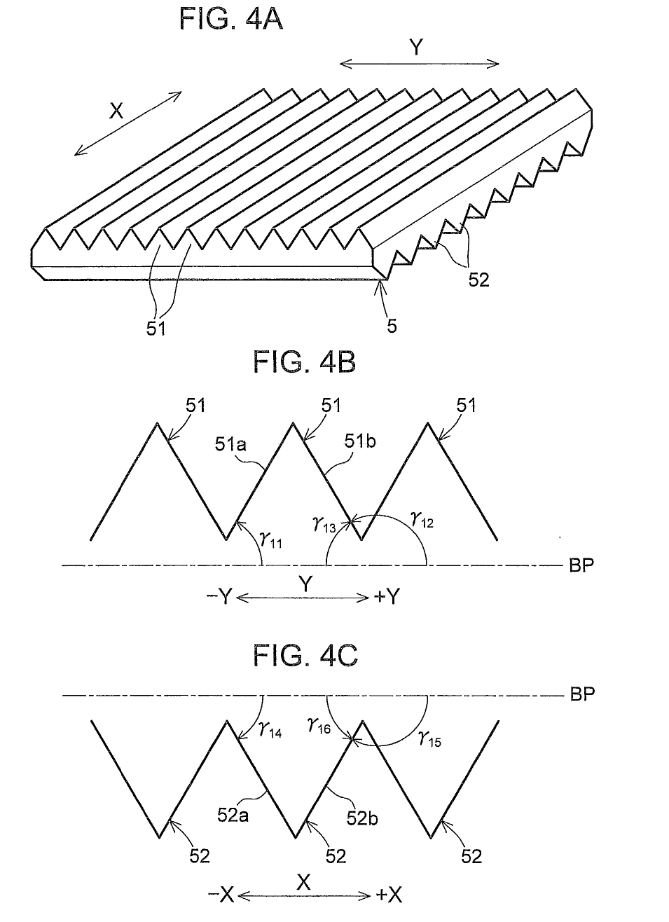

FIGS. 4A to 4C schematically illustrate an exemplary shape of the diffusion device 5 used in the projection display apparatus of the first embodiment. The diffusion device 5 as illustrated in FIG. 4A is a diffusion plate that has a light-receiving surface and a light-emitting surface. The light-receiving surface has a structure in which microscopic optical elements 51 have long and triangular-prismatic shapes extending toward the X direction perpendicular to the propagation direction of an incident light beam, and the microscopic optical elements 51 are regularly arranged along the Y direction perpendicular to both the X direction and the propagation direction. The light-emitting surface has a structure in which microscopic optical elements 52 have long and triangular-prismatic shapes extending toward the Y direction perpendicular to the propagation direction of the incident light beam, and the microscopic optical elements 52 are regularly arranged along the X direction perpendicular to both the Y direction and the propagation direction. The light-intensity uniform device 41 of FIG. 2 converts a light beam propagating from the laser sources 11 into a one-directional light beam. The converted light beam enters into one surface of the diffusion device 5 at substantially normal incidence (perpendicular) to the one surface. As illustrated in FIG. 4A, microscopic optical elements 51 extending toward the X direction are arranged in a repeated pattern along the Y direction (a first direction) on the base plane of the diffusion device 5 (i.e., a plane perpendicular to the propagation direction of the light beam propagating from the laser sources 11). The base plane of the diffusion device 5 is parallel to both the X direction and the Y direction.

FIG. 4B schematically illustrates a cross-sectional view of the microscopic optical elements 51 taken along a plane (a first perpendicular plane) which is perpendicular to a base plane (or a reference plane) BP and parallel to the Y direction. As illustrated in FIG. 4B, each microscopic optical element 51 has a first lateral surface 51a and a second lateral surface 51b. The first lateral surface 51a is inclined relative to the base plane BP of the diffusion device 5 at an acute angle γ₁₁ (i.e., an angle that measures between 0 and 90 degrees) measured in the counter-clockwise direction. The second lateral surface 51b is inclined relative to the base plane BP at an obtuse angle γ₁₂ (i.e., an angle that measures between 90 and 180 degrees) measured in the counter-clockwise direction or at an angle γ₁₃ (=180°−γ₁₂) measured in the clockwise direction. Namely, an intersection line between the first lateral surface 51a and the first perpendicular plane is inclined at the acute angle γ₁₁ relative to the Y direction (more precisely, the plus Y direction of Y increasing). An intersection line between the second lateral surface 51b and the first perpendicular plane is inclined at the obtuse angle γ₁₂ relative to the Y direction. A light beam propagating from the diffusion device 5 is refracted by each of these first and second lateral surfaces 51a and 51b.

On the other hand, the microscopic optical elements 52 extending toward the Y direction are arranged in a repeated pattern along the X direction (a second direction) on the base plane of the diffusion device 5. FIG. 4C schematically illustrates a cross-sectional view of the microscopic optical elements 52 taken along a plane (a second perpendicular plane) which is perpendicular to the base plane BP and parallel to the X direction. As illustrated in FIG. 4C, each microscopic optical element 52 has a first lateral surface 52a and a second lateral surface 52b. The first lateral surface 52a is inclined relative to the base plane BP at an acute angle γ₁₄ measured in the clockwise direction. The second lateral surface 52b is inclined relative to the base plane BP at an obtuse angle γₙ measured in the clockwise direction or at an angle γ₁₆ (=180°−γ₁₅) measured in the counter-clockwise direction. Namely, an intersection line between the first lateral surface 52a and the second perpendicular plane is inclined at the acute angle γ₁₄ relative to the X direction (more precisely, the plus X direction of X increasing). An intersection line between the second lateral surface 52b and the second perpendicular plane is inclined at the obtuse angle γ₁₅ relative to the X direction. A light beam propagating from the diffusion device 5 is refracted by each of these first and second lateral surfaces 52a and 52b. In all of the embodiments of the description, the X direction and the Y direction are perpendicular to each other, no limitation thereto intended. The X direction and the Y direction can be different directions that may not be perpendicular to each other.

The four lateral surfaces 51a, 51b, 52a and 52b of the microscopic optical elements 51 and 52, which have their respective normal vectors pointing in different directions, can refract an incident light beam so that the angular distribution of a light beam emitted by the light-receiving surface 2a of the DMD 2 becomes spread out and uniform, as will be described in more detail. The microscopic optical elements 51 in one of the two surface structures are used to spread the angular distribution in the Y direction and to improve the uniformity of the angular distribution in the Y direction. The microscopic optical elements 52 in the other are used to spread the angular distribution in the X direction and to improve the uniformity of the angular distribution in the X direction. The diffusion device 5 as illustrated in FIGS. 4A to 4C has the microscopic optical elements 51 and 52 at both the front side (or light-receiving side) and the back side (or light-emitting side), no limitation thereto intended. It should be understood that the use of a diffusion device having the microscopic optical elements 51 or 52 at only one of the front side and the back side leads to a spread-out of the angular distribution and an improvement of the uniformity of the angular distribution.

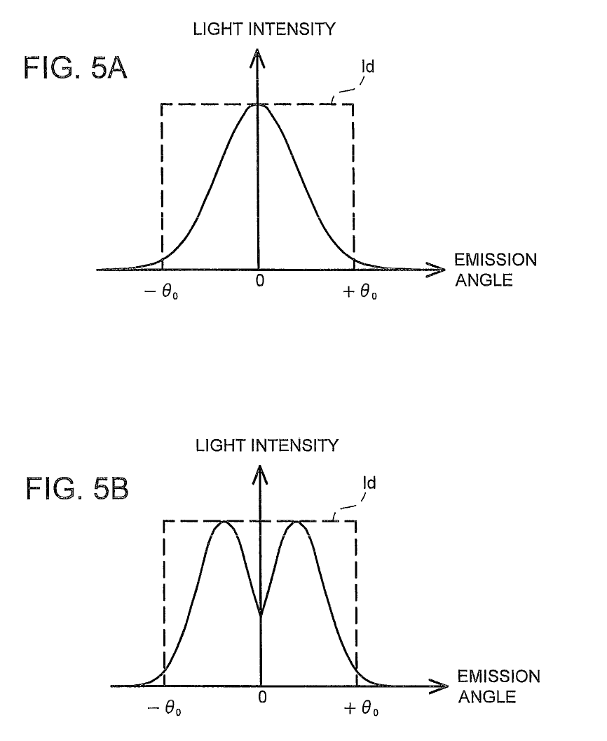

FIG. 5A graphically illustrates an effect produced by a projection display apparatus with no diffusion device as a comparative example, and FIG. 5B graphically illustrates an effect produced by the diffusion device 5 of the projection display apparatus of the first embodiment. FIGS. 5A and 5B are schematic graphs of angular distributions of light beams reflected and emitted by the light-receiving surface 2a of the DMD 2. In FIGS. 5A and 5B, the horizontal axis represents emission angle in degrees and the vertical axis represents light intensity. The emission angle of light exhibits its maximum value when the light emitted by the center of the light-receiving surface 2a passes through the edge of the pupil or aperture 32 of the projection-optical system 3 as illustrated in FIG. 2. θ₀ of FIGS. 5A and 5B denotes the maximum value (a maximum angle). The angular distributions of FIGS. 5A and 5B are light intensity distributions versus the emission angle for one of the X direction and the Y direction of the diffusion device 5. Broken lines of quadrangles are schematically illustrated in FIGS. 5A and 5B, each representing an ideal angular distribution Id that is a uniform angular distribution of a transmitted light beam. In the case of a projection display apparatus with no diffusion device, the angular distribution as illustrated in FIG. 5A has a single peak. On the other hand, in the case when a light beam passes through the prismatic microscopic optical elements 51 or 52, the angular distribution as illustrated in FIG. 5B has its two peaks that correspond to the two lateral surfaces 51a and 51b (or two lateral surfaces 52a and 52b). The angular distribution of FIG. 5B is much closer to the ideal angular distribution Id than that of FIG. 5A. In this manner, by the use of the diffusion device 5 that includes the prismatic microscopic optical elements having the characteristics illustrated in FIG. 5B, the light beam can be spread so as to effectively suppress scintillation. It is noted that, when total internal reflection of a light beam entering into the diffusion device 5 occurs at the interface between air medium and the prismatic microscopic optical elements, the light returning to the light-receiving surface of the diffusion device 5 can dissipate. In the case when the dissipation of the returning light occurs, a preferred range of the vertex angle of the prismatic microscopic optical elements (hereinafter referred to as the “prisms”) to the incidence angle of a light beam will be discussed.

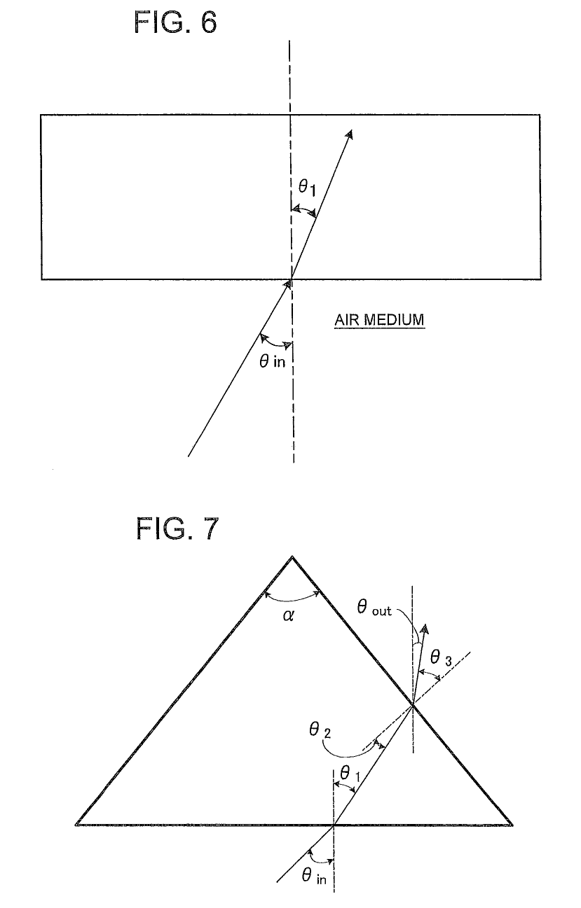

FIG. 6 illustrates refraction of a light ray. We assume that an incident light ray enters from air medium into a transparent substance with a refractive index n at an incidence angle θᵢₙ. Then the incident light ray is refracted at the angle (refraction angle) θ₁ given by the following equation (1):

$${θ}_{1} = arcsin ( \frac{sin {θ}_{in}}{n} ) . \qquad ( 1 )$$

The refracted light ray is emitted from the transparent substance into the air medium at a refraction angle whose absolute value is equal to that of θᵢₙ. When the equation (1) is not satisfied, total internal reflection of the incident light ray occurs, and the critical angle (i.e., the incidence angle for which the refraction angle is 90 degrees) can be obtained.

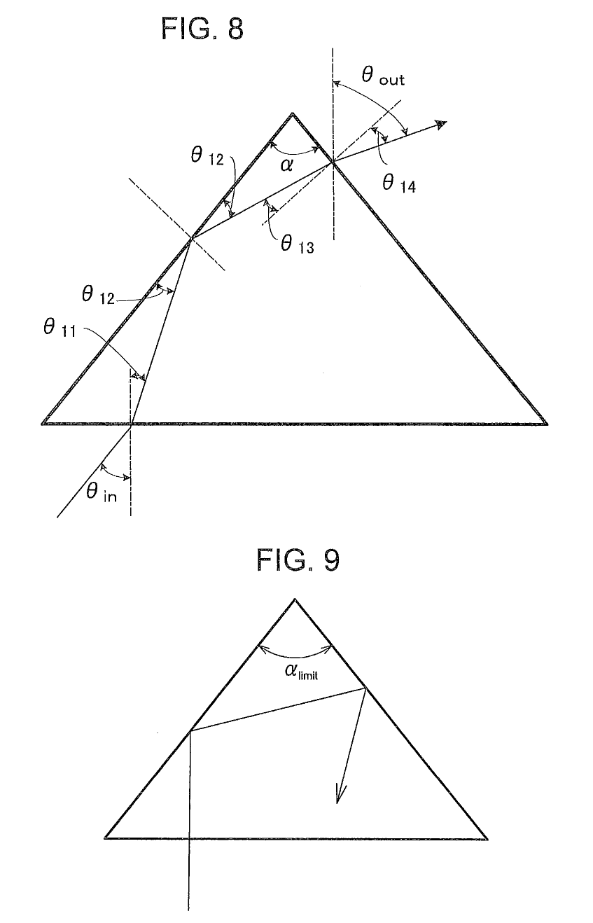

FIG. 7 schematically illustrates the refraction created by one prism of the diffusion device 5 in the projection display apparatus of the first embodiment. FIG. 8 schematically illustrates an optical function created by one prism of the diffusion device 5 in the projection display apparatus of the first embodiment. In FIGS. 7 and 8, for the sake of simplicity, the behaviour of an incident light ray and a transmitted light ray at one surface structure of the diffusion device 5 will be discussed. There are first and second functions of refraction that are created by the diffusion device 5 of the first embodiment: the first function is of refraction illustrated in FIG. 7, and the second function is of refraction illustrated in FIG. 8.

Firstly, in FIG. 7, an incident light ray entering at an incidence angle θᵢₙ is refracted at an angle (a refraction angle) θ₁ in accordance with the relational expression of the equation (1). Let α denote the vertex angle of the prism. Then an angle θ₂ is given by the following equation (2):

$${θ}_{2} = 90 - \frac{a}{2} - {θ}_{1} . \qquad ( 2 )$$

Secondly, based on the relational expression of the equation (1), an angle θ₃ is given by the following equation (3):

θ₃=arcsin(n·sin θ₂). (3)

Further, a relationship between the angle θ₃ and an emission angle θₒᵤₜ of a light ray emitted by the prism is expressed by the following equation (4):

$${θ}_{out} = 90 - \frac{a}{2} - {θ}_{3} . \qquad ( 4 )$$

As a result, the emission angle θₒᵤₜ can be expressed by the following equation (5):

$$\begin{matrix}{θ}_{out} = 90 - \frac{a}{2} - arcsin ( n \cdot sin {θ}_{2} ) \\ = 90 - \frac{a}{2} - arcsin ( n \cdot sin ( 90 - \frac{a}{2} - {θ}_{1} ) )\end{matrix} \qquad ( 5 )$$

Next, in FIG. 7, for the case where an incident light ray entering into the prism is totally internally reflected and does not pass through from the light-receiving side to its opposite side, a condition equation for the vertex angle α will be reduced. In FIG. 7, for an angle θ₃ of 90 degrees, the vertex angle α (hereinafter referred to as αₗᵢₘᵢₜ) can be given by the following equation (6):

$${a}_{limit} = 180 - 2 ( arcsin ( \frac{1}{n} ) + arcsin ( \frac{1}{n} \cdot sin {θ}_{in} ) ) . \qquad ( 6 )$$

αₗᵢₘᵢₜ of the equation (6) represents the vertex angle of the prism for which the incident light ray is totally internally reflected and cannot pass through from the light-receiving side to its opposite side, the side indicated in the upper right of FIG. 7. αₗᵢₘᵢₜ is called the critical vertex angle of the prism. Based on the above discussion, it is preferable that the refractive index and the vertex angle α of the prism be configured so that the vertex angle α of the prism is not smaller than the critical vertex angle αₗᵢₘᵢₜ.

In FIG. 8 illustrating the second function of refraction, a part of incident light rays is internally reflected once in the prism, and the reflected light ray is emitted. The incident light ray entering at an incidence angle θᵢₙ is refracted at an angle (a refraction angle) θ₁₁ in accordance with the relationship given by the equation (1). Let α denote the vertex angle of the prism. Then the refracted light ray is incident to an interface between the air medium and the prism at an angle θ₁₂ given by the following equation (7):

$${θ}_{12} = \frac{a}{2} - {θ}_{11} . \qquad ( 7 )$$

For θ₁₂ smaller than the critical angle αₗᵢₘᵢₜ described above in connection with the equation (1), total internal reflection occurs at the interface. The totally internally reflected light is incident at another interface between the air medium and the prism at an angle θ₁₃ given by the following equation (8):

$${θ}_{13} = - 90 + \frac{a}{2} - {θ}_{12} . \qquad ( 8 )$$

The incident light is emitted at an angle θ₁₄ by the prism in accordance with the relational expression of the equation (9):

θ₁₄=arcsin(n·sin θ₁₃). (9)

Finally, the angle θ₁₄ is given by the equation (10):

θ₁₄=arcsin(n·sin(−90+α−θ₁₁)) (10)

For total internal reflection of light in the prism, a condition expression of θᵢₙ will be reduced. For a critical angle θ₁₄ of 90 degrees, the vertex angle α (hereinafter referred to as αₗᵢₘᵢₜ₂) can be calculated. The critical vertex angle αₗᵢₘᵢₜ₂ is given by the following relational expression (11):

$${a}_{limit 2} = \frac{2}{3} ( arcsin ( \frac{1}{n} ) + arcsin ( \frac{1}{n} \cdot sin {θ}_{in} ) + 90 ) . \qquad ( 11 )$$

For the critical vertex angle αₗᵢₘᵢₜ₂ of the prism, an incident light ray is internally reflected as illustrated in FIG. 9 so that the reflected light ray dissipates.

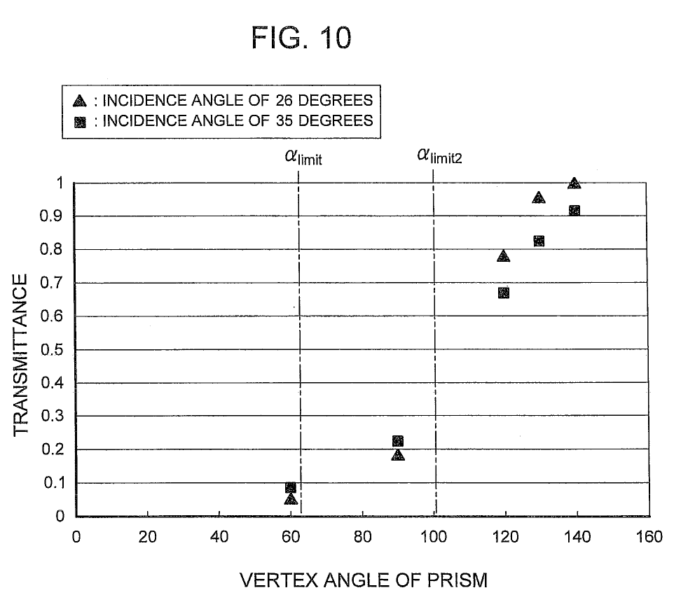

FIG. 10 graphically illustrates an effect produced by the diffusion device 5 of the projection display apparatus of the first embodiment. In FIG. 10, transmittance distributions of the diffusion device 5 having an index of refraction of 1.5 are illustrated for when the incidence angle θᵢₙ is set to 26 degrees, and when the incidence angle θᵢₙ is set to 35 degrees. In FIG. 10, critical vertex angles αₗᵢₘᵢₜ and αₗᵢₘᵢₜ₂ of the prism calculated using the equations (6) and (11) for the first and second functions of refraction of FIGS. 7 and 8 are also plotted. As illustrated in FIG. 10, the transmittance remains high in the range of high values of the vertex angle of the prism until the vertex angle reaches a critical vertex angle αₗᵢₘᵢₜ₂ corresponding to the second function of refraction (FIG. 8). Below the critical vertex angle αₗᵢₘᵢₜ₂, the transmittance decreases rapidly. Based on the fact, it is preferable that the vertex angle α of the prism be larger than the critical vertex angle αₗᵢₘᵢₜ₂ of the prism corresponding to the second function of refraction. It should be understood from the above results that the adjustment of the vertex angle α is very important to improve efficiency in the use of light.

As described above, in the first embodiment, by satisfying the relationship between the vertex angle α and the incidence angle θᵢₙ, light dissipation caused by total internal reflection of incident light in the prism can be decreased.

In the first embodiment, the prisms of the surface structures of the diffusion device 5 are arranged along each of different two directions (the X and Y directions) which are different directions perpendicular to each other, at the light-receiving and light-emitting sides. By adjusting the vertex angle of the prisms with respect to each of the light-receiving and light-emitting sides, the diffusion device 5 can provide different types of diffusion characteristics of a light beam passing through the diffusion device 5.

In the first embodiment, the diffusion device 5 is placed at or in the vicinity of the light-emitting surface 41b of the light-intensity uniform device 41. This enables the size of each optical device of the lighting-optical system to be reduced.

Laser sources 11 are used as light sources in the first embodiment. This enables the optical systems to be configured to have a long operating life, high color reproducibility, and high luminous characteristics.

Optical fibers 13 are used for guiding a light beam emitted by the light source in the first embodiment. This enables the optical system to be configured with flexibility in arrangement and with high efficiency in acquiring the light beam. Additionally, multiple reflection of the light beam in the optical fibers 13 enables scintillation to be suppressed, and enables display of an image with a uniform light intensity over a projection screen.

In the first embodiment, the light-intensity uniform device 41 can be configured by using the pipe-shaped member having a structure in which internal reflection occurs at its inner surface as described above. This enables a small range in temperature rise due to an incident light beam for illumination in the light-intensity uniform device 41. Therefore, cooling and maintenance of the light-intensity uniform device 41 can be easy.

### Second Embodiment

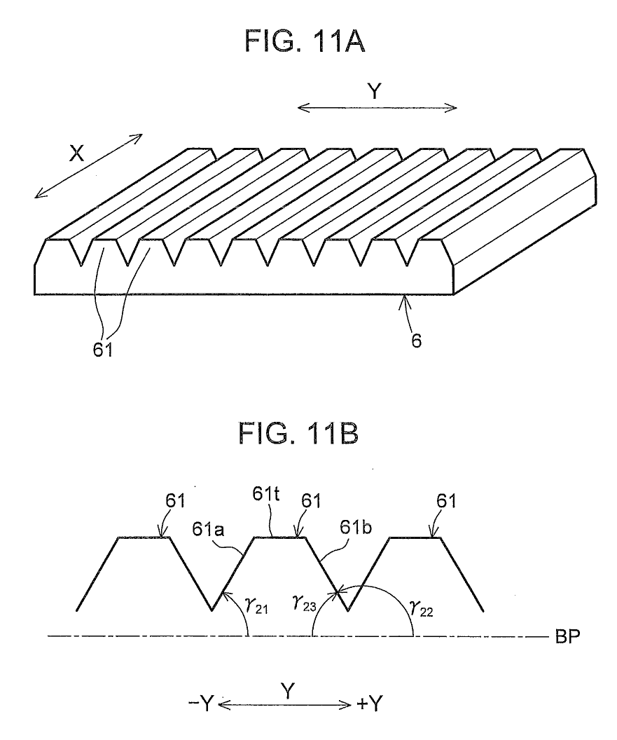

FIGS. 11A and 11B schematically illustrate the shape of a diffusion device 6 used in a projection display apparatus of a second embodiment. In the projection display apparatus of the second embodiment, the shape of the diffusion device 6 as illustrated in FIG. 11A is different from the shape of the diffusion device 5 (as illustrated in FIG. 4) of the projection display apparatus of the first embodiment. As illustrated in FIG. 11A, the diffusion device 6 of the second embodiment includes microscopic optical elements 61 each having a trapezoidal cross section structure not corresponding to the prismatic shape described above. Namely, the microscopic optical element 61 includes a quadrangular prism having a trapezoidal cross section. The diffusion device 6 is placed at or in the vicinity of the light-emitting surface 41b of the light-intensity uniform device 41, which is similar to that described in connection with the first embodiment. The diffusion device 61 can be modified not only to have microscopic optical elements 61 at one of the front and back sides, but also to have, at the other of the front and back sides, microscopic optical elements extending toward a direction (e.g., the Y direction) different from the X direction toward which the microscopic optical elements 61 extend.

Microscopic optical elements 61 extending toward the X direction are arranged in a repeated pattern along the Y direction (a first direction) on a base plane of the diffusion device 6 (i.e., a plane perpendicular to the propagation direction of the light beam propagating from the laser sources 11). FIG. 11B schematically illustrates a cross-sectional view between the microscopic optical elements 61 and a perpendicular plane which is perpendicular to a base plane (or a reference plane) BP and parallel to the Y direction. As illustrated in FIG. 11B, each microscopic optical element 61 has a first lateral surface 61a and a second lateral surface 61b. The first lateral surface 61a is inclined relative to the base plane BP of the diffusion device 6 at an acute angle γₙ measured in the counter-clockwise direction. The second lateral surface 61b is inclined relative to the base plane BP at an obtuse angle γ₂₂ measured in the counter-clockwise direction or at an angle γ₂₃ (=180°−γ₂₂) measured in the clockwise direction. Namely, an intersection line between the first lateral surface 61a and the perpendicular plane is inclined at the acute angle γₙ relative to the Y direction (more precisely, the plus Y direction of Y increasing). Each microscopic optical element 61 as illustrated in FIG. 11B further has a top surface 61t that is parallel to the base plane BP. A light beam propagating from the laser sources 11 is refracted by each of these three surfaces of the first and second lateral surfaces 61a and 61b, and the top surface 61t. These three surfaces of the microscopic optical element 61, which have their respective normal vectors pointing in different directions, can refract an incident light beam so that the angular distribution of a light beam emitted by the light-receiving surface 2a of the DMD 2 becomes spread out and uniform in the Y direction.

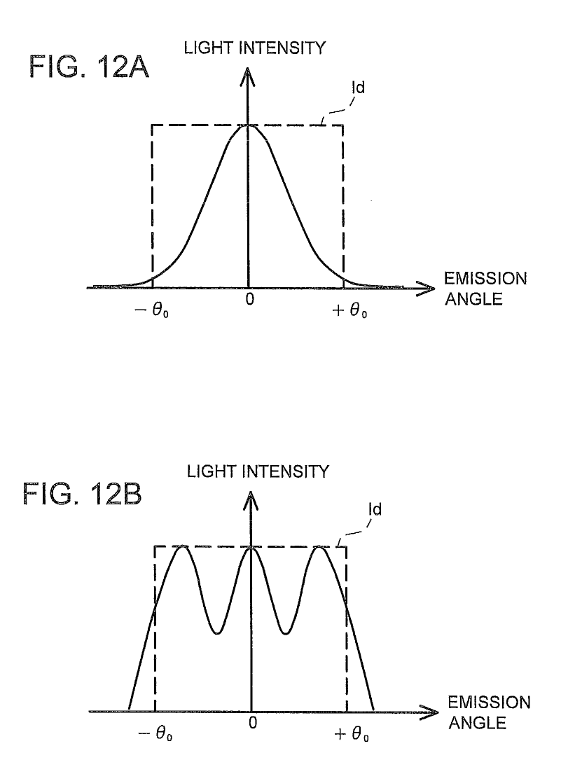

FIG. 12A graphically illustrates an effect produced by a projection display apparatus with no diffusion device as a comparative example, and FIG. 12B graphically illustrates an effect produced by the diffusion device 6 of the projection display apparatus of the second embodiment. FIGS. 12A and 12B are schematic graphs of angular distributions of light beams reflected and emitted by the light-receiving surface 2a of the DMD 2. In FIGS. 12A and 12B, the horizontal axis represents emission angle in degrees and the vertical axis represents light intensity. The emission angle of light exhibits its maximum value when the light emitted by the center of the light-receiving surface 2a passes through the edge of the pupil or aperture 32 of the projection-optical system 3. θ₀ of FIGS. 12A and 12B denotes the maximum value (a maximum angle). The angular distribution of FIG. 12A is a light intensity distribution obtained by a projection display apparatus with no diffusion device. The angular distribution of FIG. 12B is a light intensity distribution of the light beam passing through the diffusion device 6. Broken lines of quadrangles are schematically illustrated in FIGS. 12A and 12B, each representing an ideal angular distribution Id that is a uniform angular distribution of a transmitted light beam. In the case of a projection display apparatus with no diffusion device, the angular distribution as illustrated in FIG. 12A has a single peak. On the other hand, in the case when a light beam passes through the prismatic microscopic optical elements 61, the angular distribution as illustrated in FIG. 12B has its three peaks that correspond to the two lateral surfaces 61a and 61b, and the top surface 61t of the microscopic optical element 61. The angular distribution of FIG. 12B is much closer to the ideal angular distribution Id than that of FIG. 12A. In this manner, by the use of the diffusion device 6 that includes the microscopic optical elements 61 having the characteristics illustrated in FIG. 12B, the light beam can be spread so as to effectively suppress scintillation.

The configuration of the projection display apparatus of the second embodiment is identical to that of the projection display apparatus of the first embodiment, except for the diffusion device 6.

### Third Embodiment

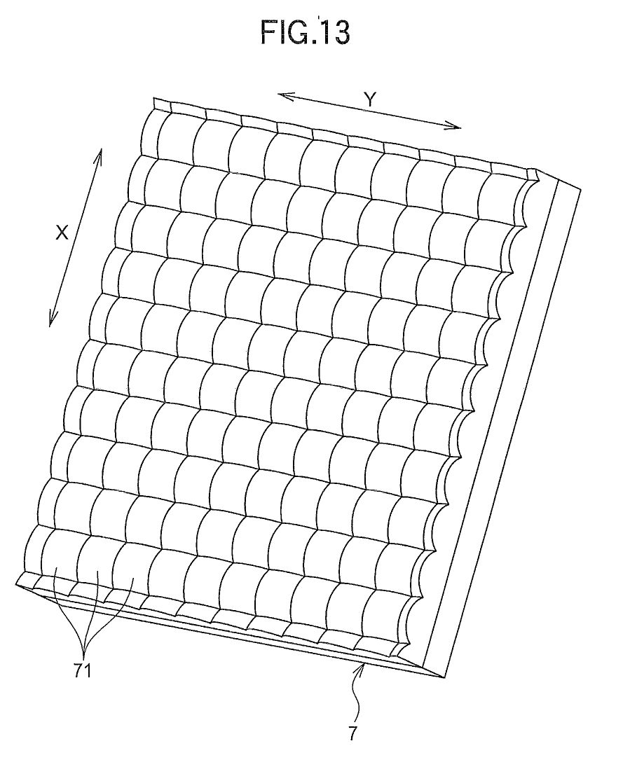

FIG. 13 schematically illustrates the shape of a diffusion device 7 used in a projection display apparatus of a third embodiment. In the projection display apparatus of the third embodiment, the shape of the diffusion device 7 as illustrated in FIG. 13 is different from the shapes of the diffusion devices 5 and 6 (as illustrated in FIGS. 4 and 11) of the projection display apparatuses of the first and second embodiments. As illustrated in FIG. 13, the diffusion device 7 of the third embodiment has a surface structure in which microlenses (lens elements) as microscopic optical elements 71 are regularly arranged in a two-dimensional array. In the third embodiment, desired diffusion characteristics can be obtained by optimally adjusting physical parameters such as the index of refraction of the microlenses for incident light, and the curvature of the microlenses. As illustrated in the perspective view of the FIG. 13, each microscopic optical element 71 has curved surface portions that are inclined toward the plus X direction, the minus X direction, the plus Y direction, and the minus Y direction, respectively. Each microscopic optical element 71 further has curved surface portions that are inclined toward directions other than the X and Y directions. These curved surface portions enable controlling of the angular distribution of the light beam emitted from the light-receiving surface 2a of the DMD 2 not only with respect to the X and Y directions, but also with respect to the directions other than the X and Y directions.

The microscopic optical element 71 has a lens shape. Nonetheless, incident light entering at an angle larger than a critical angle can be totally internally reflected in the microscopic optical element 7, resulting in light dissipation. In order to avoid the light dissipation, the curvature of the microlenses and the incidence angle of the incident light are needed to be selected as similar to the case of the first embodiment. In the third embodiment, with the addition of the diffusion device 7, the decrease of efficiency in the use of light emitted by laser sources 11 can be avoided and scintillation can be effectively suppressed so that a high-quality image can be displayed.

The configuration of the projection display apparatus of the third embodiment is identical to that of the projection display apparatus of the first embodiment, except for the diffusion device 7.

### Fourth Embodiment

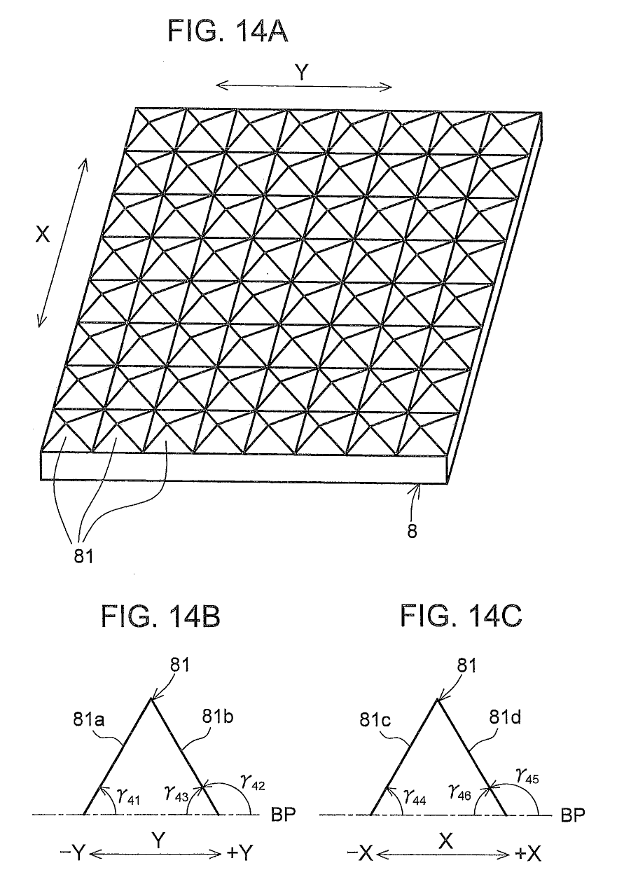

FIGS. 14A to 14C schematically illustrate the shape of a diffusion device 8 used in a projection display apparatus of a fourth embodiment. The shape of the diffusion device 8 as illustrated in a perspective view of FIG. 14A is different from the shapes of the diffusion devices 5, 6, and 7 (as illustrated in FIGS. 4, 11, and 13) of the projection display apparatuses of the first, second and third embodiments. As illustrated in FIG. 14A, the diffusion device 8 of the fourth embodiment has a surface structure (at the light-receiving surface side or the light-emitting surface side) in which microscopic optical elements 81 each having a quadrangular pyramid structure are regularly arranged in a two-dimensional array (e.g., in a matrix). Each microscopic optical element 81 has four lateral surfaces (first to fourth lateral surfaces) that are inclined relative to a base plane of the diffusion device 8 (i.e., a plane perpendicular to the propagation direction of the light beam propagating from the laser sources 11). These first to fourth lateral surfaces have their respective normal vectors pointing in different directions. FIG. 14B schematically illustrates a cross-sectional view of the microscopic optical elements 81 taken along a plane (a first perpendicular plane) which is perpendicular to the base plane BP and parallel to the Y direction. As illustrated in FIG. 14B, each microscopic optical element 81 has a first lateral surface 81a and a second lateral surface 81b. The first lateral surface 81a is inclined relative to the base plane BP at an acute angle γ₄₁ measured in the counter-clockwise direction. The second lateral surface 81b is inclined relative to the base plane BP at an obtuse angle γ₄₂ measured in the counter-clockwise direction or at an angle γ₄₃ (=180°−γ₄₂) measured in the clockwise direction. Namely, an intersection line between the first lateral surface 81a and the first perpendicular plane is inclined at the acute angle γ₄₁ relative to the Y direction (more precisely, the plus Y direction of Y increasing). An intersection line between the second lateral surface 81b and the first perpendicular plane is inclined at the obtuse angle γ₄₂ relative to the Y direction. FIG. 14C schematically illustrates a cross-sectional view of the microscopic optical elements 81 taken along a plane (a second perpendicular plane) which is perpendicular to the base plane BP and parallel to the X direction. As illustrated in FIG. 14C, each microscopic optical element 81 has a third lateral surface 81c and a fourth lateral surface 81d. The third lateral surface 81c is inclined relative to the base plane BP at an acute angle γ₄₄ measured in the counter-clockwise direction. The fourth lateral surface 81d is inclined relative to the base plane BP at an obtuse angle γ₄₅ measured in the counter-clockwise direction or at an angle γ₄₆ (=180°−γ₄₅) measured in the clockwise direction. Namely, an intersection line between the third lateral surface 81c and the second perpendicular plane is inclined at the acute angle γ₄₄ relative to the X direction (more precisely, the plus X direction of X increasing). An intersection line between the fourth lateral surface 81d and the second perpendicular plane is inclined at the obtuse angle γ₄₅ relative to the X direction. These four lateral surfaces 81a, 81b, 81c and 81d, which have their respective normal vectors pointing in different directions, can refract an incident light beam so that the angular distribution of a light beam emitted by the light-receiving surface 2a of the DMD 2 becomes spread out and uniform in the X and Y directions. In addition, the angular distribution can be controlled by optimally adjusting the height and the geometry of the base plane of the quadrangular pyramid structure of the diffusion device 81.

Therefore, in the fourth embodiment, with the addition of the diffusion device 8, the decrease of efficiency in the use of light emitted by laser sources 11 can be avoided and scintillation can be effectively suppressed so that a high-quality image can be displayed.

The configuration of the projection display apparatus of the fourth embodiment is identical to that of the projection display apparatus of the first embodiment, except for the diffusion device 8.

### Fifth Embodiment

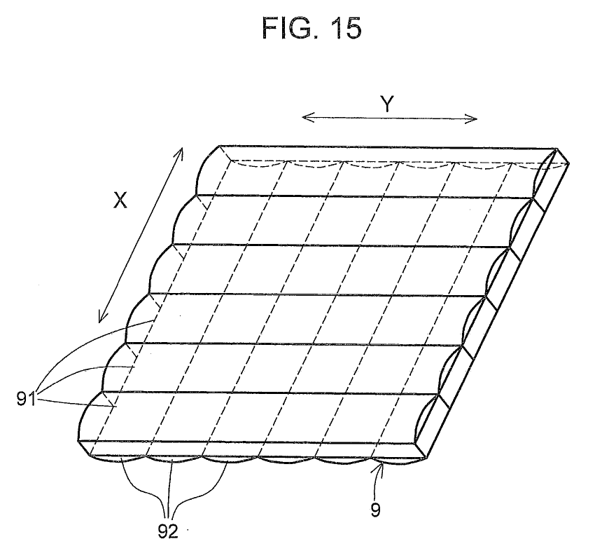

FIG. 15 schematically illustrates the shape of a diffusion device 9 used in a projection display apparatus of a fifth embodiment. In the projection display apparatus of the fifth embodiment, the shape of the diffusion device 9 as illustrated in FIG. 15 is different from the shapes of the diffusion devices 5, 6, 7, and 8 (as illustrated in FIGS. 4, 11, 13, and 14) of the projection display apparatuses of the first, second, third and fourth embodiments. The diffusion device 9 of the fifth embodiment as illustrated in FIG. 15, in its front-side surface structure, includes microscopic optical elements 91 each of which has a semicylindrical shape and is circular in cross section, not corresponding to the prismatic shapes described above. The diffusion device 9 further includes microscopic optical elements 92 each having a semicylindrical shape in its back-side surface structure. The microscopic optical elements 91 in the front-side surface structure extend toward the Y direction, and the microscopic optical elements 92 in the back-side surface structure extend toward the X direction perpendicular to the Y direction. As illustrated in the perspective view of FIG. 15, each microscopic optical element 91 in the front-side surface structure has two types of curved surface portions which are inclined toward the X direction at their respective different ranges of angles relative to a base plane of the diffusion device 9 (i.e., a plane perpendicular to the propagation direction of the light beam propagating from the laser sources 11). Each microscopic optical element 92 in the back-side surface structure has two types of curved surface portions which are inclined toward the Y direction at their respective different ranges of angles relative to the base plane. These four curved surface portions, which have their respective normal vectors pointing in different directions, can refract an incident light beam so that the angular distribution of a light beam emitted by the light-receiving surface 2a of the DMD 2 becomes spread out and uniform in the X and Y directions. In addition, the angular distribution can be controlled by optimally adjusting the curvature radius of their semicylindrical shapes and the pitch, the distance between the microscopic optical elements.

Therefore, in the fifth embodiment, with the addition of the diffusion device 9, the decrease of efficiency in the use of light emitted by laser sources 11 can be avoided and scintillation can be effectively suppressed so that a high-quality image can be displayed.

The configuration of the projection display apparatus of the fifth embodiment is identical to that of the projection display apparatus of the first embodiment, except for the diffusion device 9.

### Sixth Embodiment

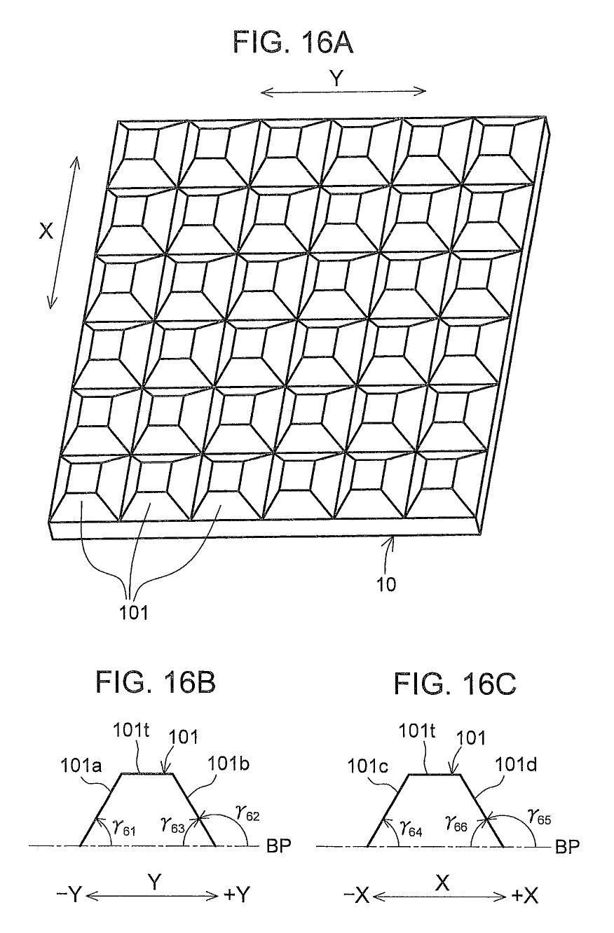

FIGS. 16A to 16C schematically illustrate the shape of a diffusion device 10 used in a projection display apparatus of a sixth embodiment. In the projection display apparatus of the sixth embodiment, the shape of the diffusion device 10 as illustrated in FIG. 16 is different from the shapes of the diffusion devices 5, 6, 7, 8 and 9 (as illustrated in FIGS. 4, 11, 13, 14 and 15) of the projection display apparatuses of the first, second, third, fourth and fifth embodiments. The diffusion device 10 as illustrated in FIG. 16 has a surface structure in which microscopic optical elements 101 are regularly arranged in a two-dimensional array (e.g., in a matrix). Each microscopic optical element 101 has a trapezoidal cross section equivalent to a cross section of a truncated shape obtained by cutting a vertex portion of a quadrangular pyramid structure. As illustrated in the perspective view of FIG. 16, each microscopic optical element 101 in the front-side surface structure has four lateral surfaces (first to fourth lateral surfaces) that are inclined relative to a base plane of the diffusion device 10 (i.e., a plane perpendicular to the propagation direction of the light beam propagating from the laser sources 11). These first to fourth lateral surfaces have their respective normal vectors pointing in different directions. FIG. 16B schematically illustrates a cross-sectional view of the microscopic optical elements 101 taken along a plane (a first perpendicular plane) which is perpendicular to a base plane (or a reference plane) BP and parallel to the Y direction. As illustrated in FIG. 16B, each microscopic optical element 101 has a first lateral surface 101a and a second lateral surface 101b. The first lateral surface 101a is inclined relative to the base plane BP at an acute angle γ₆₁ measured in the counter-clockwise direction. The second lateral surface 101b is inclined relative to the base plane BP at an obtuse angle γ₆₂ measured in the counter-clockwise direction or at an angle γ₆₃ (=180°−γ₆₂) measured in the clockwise direction. Namely, an intersection line between the first lateral surface 101a and the first perpendicular plane is inclined at the acute angle γ₆₁ relative to the Y direction (more precisely, the plus Y direction of Y increasing). An intersection line between the second lateral surface 101b and the first perpendicular plane is inclined at the obtuse angle γ₆₂ relative to the Y direction. On the other hand, FIG. 16C schematically illustrates a cross-sectional view of the microscopic optical elements 101 taken along a plane (a second perpendicular plane) which is perpendicular to the base plane BP and parallel to the X direction. As illustrated in FIG. 16C, each microscopic optical element 101 has a third lateral surface 101c and a fourth lateral surface 101d. The third lateral surface 101c is inclined relative to the base plane BP at an acute angle γ₆₄ measured in the counter-clockwise direction. The fourth lateral surface 101d is inclined relative to the base plane BP at an obtuse angle γ₆₅ measured in the counter-clockwise direction or at an angle γ₆₆ (=180°−γ₆₅) measured in the clockwise direction. Namely, an intersection line between the third lateral surface 101c and the second perpendicular plane is inclined at the acute angle γ₆₄ relative to the X direction (more precisely, the plus X direction of X increasing). An intersection line between the fourth lateral surface 101d and the second perpendicular plane is inclined at the obtuse angle γ₆₅ relative to the X direction. Each microscopic optical element 101 further has a top surface 101t that is parallel to the base plane BP. These lateral surfaces 101a, 101b, 101c and 101d and the top surface 101t can refract an incident light beam so that the angular distribution of a light beam emitted by the light-receiving surface 2a of the DMD 2 becomes spread out and uniform in the X and Y directions. In addition, the angular distribution can be controlled by optimally adjusting the geometry of the base and the shape of the trapezoidal cross section of the microscopic optical element 101.

Therefore, in the sixth embodiment, with the addition of the diffusion device 10, the decrease of efficiency in the use of light emitted by laser sources 11 can be avoided and scintillation can be effectively suppressed so that a high-quality image can be displayed.

The configuration of the projection display apparatus of the sixth embodiment is identical to that of the projection display apparatus of the first embodiment, except for the diffusion device 10.

As described above, in the projection display apparatuses of the first to sixth embodiments, the DMD 2, a light valve, modulates a light beam collected by the lighting-optical system 4 to generate an image light. The projection-optical system 3 enlarges and projects the image light onto the screen 33. In this system, any of the diffusion devices 5, 6, 7, 8, 9, and 10 located in the lighting-optical system 4 controls the angular distribution of the image light emitted by the DMD 2 thereby to spread the angular distribution and to improve the uniformity of the angular distribution. This increases the number of various wave fronts entering into the screen 33. The various wave fronts form interference patterns at the screen 33. The interference patterns are superposed to generate an averaged pattern which can be seen by a viewer, thus resulting in suppressing of scintillation.

What is claimed is:

1. A projection display apparatus comprising:
at least one light source for emitting a coherent light beam;
a light valve having an image-forming region for modulating a light beam propagating from said at least one light source, thereby to generate and emit an image light beam;
a lighting-optical system for guiding to said image-forming region the light beam propagating from said at least one light source;
a projection-optical system for enlarging and projecting said image light beam emitted by said image-forming region; and
a diffusion device located in said lighting-optical system, said diffusion device being located at or in a vicinity of a position optically conjugated with said image-forming region, and having a structure in which a plurality of microscopic optical elements is regularly arranged on a base plane perpendicular to a propagation direction of a light beam propagating from said at least one light source.

2. The projection display apparatus according to claim 1, wherein said diffusion device has a structure in which said plurality of microscopic optical elements is arranged in at least one of a light-incident surface structure and a light-emitting surface structure of said diffusion device.

3. The projection display apparatus according to claim 1, wherein:
said diffusion device has a structure in which said plurality of microscopic optical elements is arranged in both of a light-incident surface structure and a light-emitting surface structure of said diffusion device; and
each of said microscopic optical elements arranged in said light-incident surface structure has a different shape from each of said microscopic optical elements arranged in said light-emitting surface structure.

4. The projection display apparatus according to claim 2, wherein:
said microscopic optical elements are arranged in a repeated pattern along a first direction on said base plane, said each microscopic optical element having a first lateral surface and a second lateral surface;
an intersection line between said first lateral surface and a first perpendicular plane which is a plane perpendicular to said base plane and parallel to said first direction is inclined at an acute angle relative to said first direction; and
an intersection line between said second lateral surface and said first perpendicular plane is inclined at an obtuse angle relative to said first direction.

5. The projection display apparatus according to claim 3, wherein:
said microscopic optical elements in one surface structure of said light-incident surface structure and said light-emitting surface structure are arranged in a repeated pattern along a first direction on said base plane, each of the arranged microscopic optical elements in said one surface structure having a first lateral surface and a second lateral surface;
an intersection line between said first lateral surface and a first perpendicular plane which is a plane perpendicular to said base plane and parallel to said first direction is inclined at an acute angle relative to said first direction;
an intersection line between said second lateral surface and said first perpendicular plane is inclined at an obtuse angle relative to said first direction;
said microscopic optical elements in the other surface structure of said light-incident surface structure and said light-emitting surface structure are arranged in a repeated pattern along a second direction different from said first direction on said base plane, each of said arranged microscopic optical elements in the other surface structure having a third lateral surface and a fourth lateral surface;
an intersection line between said third lateral surface and a second perpendicular plane which is a plane perpendicular to said base plane and parallel to said second direction is inclined at an acute angle relative to said second direction; and
an intersection line between said fourth lateral surface and said second perpendicular plane is inclined at an obtuse angle relative to said second direction.

6. The projection display apparatus according to claim 4, wherein each of said microscopic optical elements is prismatic in shape.

7. The projection display apparatus according to claim 5, wherein each of said microscopic optical elements is prismatic in shape.

8. The projection display apparatus according to claim 4, wherein each of said microscopic optical elements has a trapezoidal cross section equivalent to a cross section of a truncated shape obtained by cutting a vertex portion of a microscopic optical element which is prismatic in shape.

9. The projection display apparatus according to claim 5, wherein each of said microscopic optical elements has a trapezoidal cross section equivalent to a cross section of a truncated shape obtained by cutting a vertex portion of a microscopic optical element which is prismatic in shape.

10. The projection display apparatus according to claim 4, wherein:
in addition to said first and second lateral surfaces, said each microscopic optical element has a third lateral surface and a fourth lateral surface;
an intersection line between said third lateral surface and a second perpendicular plane which is a plane perpendicular to said base plane and parallel to a second direction different from said first direction is inclined at an acute angle relative to said second direction; and
an intersection line between said fourth lateral surface and said second perpendicular plane is inclined at an obtuse angle relative to said second direction.

11. The projection display apparatus according to claim 10, wherein said each microscopic optical element has a quadrangular pyramid structure.

12. The projection display apparatus according to claim 10, wherein said each microscopic optical element has a trapezoidal cross section equivalent to a cross section of a truncated shape obtained by cutting a vertex portion of a microscopic optical element which has a quadrangular pyramid structure.

13. The projection display apparatus according to claim 1, wherein said diffusion device is a lens array in which lens elements are arranged in a two-dimensional array as said plurality of microscopic optical elements.

14. The projection display apparatus according to claim 1, wherein each of said microscopic optical elements is semicylindrical in shape.

15. The projection display apparatus according to claim 1, wherein said at least one light source includes at least one laser source.
